(19) United States
(12) Patent Application Publication
(10) Pub. No.: US 2011/0219406 A1
(43) Pub. Date: Sep. 8, 2011

(54) MOBILE BROADCASTING APPARATUS AND METHOD WITH POSITION INFORMATION PROVIDED BY MOBILE COMMUNICATION SYSTEM

(75) Inventor: Chung-Jen Chen, Taipei (TW)

(73) Assignee: AVERMEDIA TECHNOLOGIES, INC., Taipei (TW)

(21) Appl. No.: 13/013,528

(22) Filed: Jan. 25, 2011

(30) Foreign Application Priority Data
Mar. 5, 2010 (TW) 099106451

(51) Int. Cl. H04N 7/16

(52) U.S. Cl. 725/62

(57) ABSTRACT

A mobile broadcasting method, applied to a mobile broadcasting apparatus, includes steps of: obtaining a first position information via a signal connection between the mobile broadcasting apparatus and a communication system; obtaining a first channel information table according to the first position information; obtaining a first frequency band included in the first channel information table; receiving a first wireless broadcast signal at the first frequency band and playing a corresponding channel program; obtaining a second position information via a signal connection between the mobile broadcasting apparatus and the communication system when the mobile broadcasting apparatus is moved; obtaining a second channel information table according to the second position information; obtaining a corresponding second frequency band included in the second channel information table; and receiving a second wireless broadcast signal at the second frequency band and playing the corresponding channel program.

### FIELD OF THE INVENTION

The present invention is related to a mobile broadcasting apparatus and associated broadcasting method with wireless channel program receiving function, and more particularly to a mobile broadcasting apparatus and associated broadcasting method provided with position information through a mobile communication system.

### BACKGROUND OF THE INVENTION

Compared to a traditional analog television (TV) or a cable TV, a digital TV is removable and has a higher image quality. Today, the function of a digital TV is combined with some mobile broadcasting apparatuses such as a notebook computer or a PDA. Because these mobile broadcasting apparatuses are removable, a user can watch a digital channel program via the mobile broadcasting apparatus in a car when the car is moving.

Basically, the digital channel program produced by a TV station is firstly converted to wireless broadcast signals, and the wireless broadcast signals are then broadcast from multiple broadcast base stations of the TV station at a specific frequency band. The digital channel program is then broadcast on a mobile broadcasting apparatus after the wireless broadcast signals are received and processed by the mobile broadcasting apparatus.

However, a same frequency band may be allocated to different channel programs in different zones. That is, a first frequency band may be allocated to a first channel program in a first zone, but to a second channel program in a second zone. Allocating a same frequency band to two different channel programs in two different zones may cause some problems, for example, if a user uses a mobile broadcasting apparatus in a car to watch a first channel program at a first frequency band in the first zone, but a second channel program may be broadcast on the mobile broadcasting apparatus at the same first frequency band when the user drives to the second zone.

FIG. 1 is a schematic diagram illustrating two TV broadcast stations broadcasting a same channel program at two different frequency bands in two different zones. As depicted in FIG. 1, a TV broadcast station 11 broadcasts a channel program α at a frequency band 521 MHz in the zone A; and another TV broadcast station 12 broadcasts the same channel program α at a frequency band 587 MHz in the zone B. If a user in a car in the zone A would like to use a mobile broadcasting apparatus 13, for example, a notebook computer or a PDA, to watch the channel program α, he can switch the mobile broadcasting apparatus 13 to the frequency band 521 MHz, thereby wireless broadcast signals corresponding to the channel program α are then transmitted to the mobile broadcasting apparatus 13 from the first TV broadcast station 11 at the frequency band 521 MHz. After the wireless broadcast signals corresponding to the channel program α are received and processed by the mobile broadcasting apparatus 13, the channel program α is accordingly broadcast on the mobile broadcasting apparatus 13. However, if the user drives to the zone B and he still likes to watch the same channel program α in the zone B, he has to manually switch the mobile broadcasting apparatus 13 from the frequency band 521 MHz to 587 MHz, so that the wireless broadcast signals corresponding to the channel program α are transmitted to the mobile broadcasting apparatus 13 from the second TV broadcast station 12 at the frequency band 587 MHz.

It is understood that the user can watch the channel program a through both the frequency bands 521 MHz or 587 MHz in the overlapped area of the two zones A and B. Moreover, it is understood that another channel program β would be broadcast on the mobile broadcasting apparatus 13 if the user keeps the mobile broadcasting apparatus 13 to work at the frequency band 521 MHz in the zone B.

It is inconvenient for a user to manually switch a mobile broadcasting apparatus to different frequency bands in different zones for watching a same channel program.

### SUMMARY OF THE INVENTION

Therefore, the object of the present invention is to provide a mobile broadcasting apparatus and its related broadcasting method with wireless channel program receiving function. For watching a same channel program, the mobile broadcasting apparatus is automatically switched from a first frequency band to a second frequency band when the mobile broadcasting apparatus is moved from a first zone to a second zone, so that a user of the mobile broadcasting apparatus does not need to manually switch the frequency band when the mobile broadcasting apparatus is moved to another zone.

An embodiment of the present invention provides a mobile broadcasting method, applied to a mobile broadcasting apparatus with wireless channel program receiving function, and comprising steps of: obtaining a first position information of the mobile broadcasting apparatus via a signal connection between the mobile broadcasting apparatus and a communication system; selecting a first channel information table from a plurality of channel information tables according to the first position information; selecting a first frequency band from a plurality of frequency bands included in the first channel information table; receiving a first wireless broadcast signal at the first frequency band and playing a channel program corresponding to the first wireless broadcast signal on the mobile broadcasting apparatus; obtaining a second position information of the mobile broadcasting apparatus via a signal connection between the mobile broadcasting apparatus and the communication system when the mobile broadcasting apparatus is moved; selecting a second channel information table from the plurality of channel information tables according to the second position information; selecting a second frequency band, corresponding to the channel program, from the plurality of frequency bands included in the second channel information table; and receiving a second wireless broadcast signal at the second frequency band and playing the channel program corresponding to the second wireless broadcast signal on the mobile broadcasting apparatus.

In one embodiment, when the communication system is a mobile communication system, the above mentioned step of selecting a first channel information table from a plurality of channel information tables according to the first position information further comprises steps of: obtaining the plurality of channel information tables from a mobile communication servo of the mobile communication system; and selecting the first channel information table from the plurality of channel information tables by the mobile communication servo according to the first position information.

In one embodiment, when the communication system is a network system, the above mentioned step of selecting a first channel information table from a plurality of channel information tables according to the first position information further comprises steps of: obtaining the plurality of channel information tables from a network servo of the network system; and selecting the first channel information table from the plurality of channel information tables by the network servo according to the first position information.

In one embodiment, when the communication system is a mobile communication system, the above mentioned step of selecting a first channel information table from a plurality of channel information tables according to the first position information further comprises steps of: obtaining the plurality of channel information tables from a mobile communication servo of the mobile communication system; and selecting the first channel information table from the plurality of channel information tables by the mobile broadcasting apparatus according to the first position information.

In one embodiment, when the communication system is a network system, the above mentioned step of selecting a first channel information table from a plurality of channel information tables according to the first position information further comprises steps of: obtaining the plurality of channel information tables from a network servo of the network system; and selecting the first channel information table from the plurality of channel information tables by the mobile broadcasting apparatus according to the first position information.

In one embodiment, the above mentioned step of selecting a first frequency band from a plurality of frequency bands included in the first information table, the first frequency band is selected according to a channel program name; and the channel program name is selected by a user or preset in the mobile broadcasting apparatus.

Another embodiment of the present invention provides a mobile broadcasting apparatus with wireless channel program receiving function, in signal connection to a communication system, the mobile broadcasting apparatus comprises: a signal receiving unit, in signal connection to the communication system; and a play unit electrically connected to the signal receiving unit; wherein a first position information of the mobile broadcasting apparatus is obtained via the signal receiving unit in signal connection to the communication system when the mobile broadcasting apparatus is positioned in a first zone, a first channel information table in a plurality of channel information tables is selected according to the first position information, a first frequency band in a plurality of frequency bands included in the first channel information table is selected, a channel program corresponding to a first wireless broadcast signal is played on the play unit after the first wireless broadcast signal is transmitted to the signal receiving unit at the first frequency band; a second position information of the mobile broadcasting apparatus is obtained via the signal receiving unit in signal connection to the communication system when the mobile broadcasting apparatus is positioned in a second zone, a second channel information table in the plurality of channel information tables is selected according to the second position information, a second frequency band, corresponding to the channel program, in the plurality of frequency bands included in the second channel information table is selected, the channel program corresponding to a second wireless broadcast signal is played on the play unit after the second wireless broadcast signal is transmitted to the signal receiving unit at the second frequency band.

In one embodiment, the mobile broadcasting apparatus with wireless channel program receiving function further comprises: a memory unit, electrically connected to the play unit, for storing the plurality of channel information tables.

In one embodiment, the plurality of channel information tables is obtained from a mobile communication servo if the communication system is a mobile communication system.

In one embodiment, the plurality of channel information tables is obtained from a network servo if the communication system is a network system.

In one embodiment, the position information is obtained from the communication system or obtained through the mobile broadcasting apparatus by computing an identifying signal which is transmitted from the communication system.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic diagram illustrating two TV broadcast stations broadcasting a same channel program at two different frequency bands in two different zones;

FIG. 2A is a block diagram of a mobile broadcasting apparatus according to an embodiment of the present invention;

FIG. 2B is a schematic diagram illustrating a mobile broadcasting apparatus is positioned by computing communication signals transmitted from multiple communication base stations;

FIG. 3A is a flow chart of a broadcasting method applied to a mobile broadcasting apparatus, according to an embodiment of the present invention; and

FIG. 3B is a flow chart of an operating method applied to a mobile broadcasting apparatus according to an embodiment of the present invention.

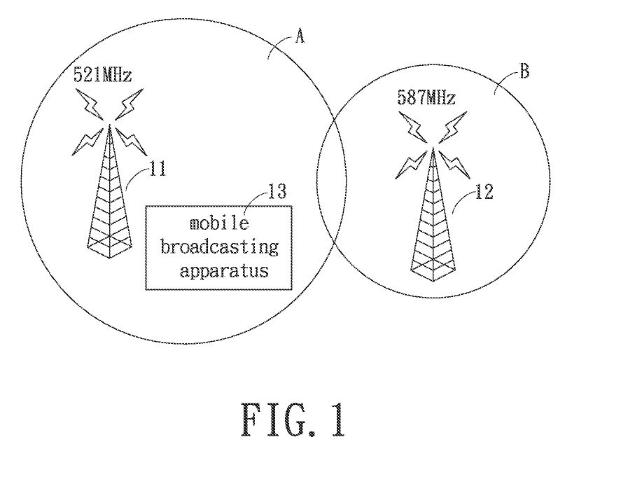

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The present invention is related to a mobile broadcasting apparatus with positioning function. If the mobile broadcasting apparatus of the embodiment of the present invention in a first zone is playing a channel program at a first frequency band, the mobile broadcasting apparatus is automatically switched to a second frequency band for playing the same channel program after the mobile broadcasting apparatus is moved to a second zone

For positioning the mobile broadcasting apparatus, a GPS (Global positioning System) is adopted in the mobile broadcasting apparatus of the embodiment of the present invention. In a GPS, a position is achieved by processing signals transmitted from multiple satellites. However, the cost of a GPS is relatively high and the signals transmitted from the satellites may blocked by buildings. Moreover, extra circuits are necessarily implemented in the mobile broadcasting apparatus for combining the GPS. Therefore, it is not so practical to adopt a GPS in a mobile broadcasting apparatus.

The positioning function adopted in the mobile broadcasting apparatus is for determining the zone of the mobile broadcasting apparatus moved to. In other words, the positioning function adopted in the mobile broadcasting apparatus is for determining in which one of the first zone and the second zone the mobile broadcasting apparatus is located, for example; so the requirement of the positioning accuracy is not needed as high as that of GPS.

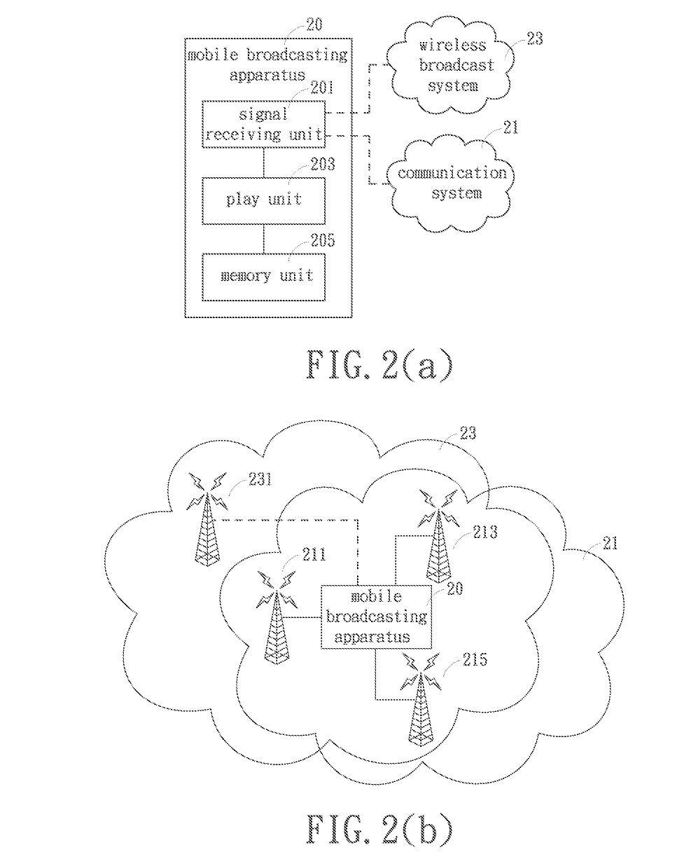

Therefore, a communication system, i.e., a mobile communication system or a wireless network system, can be adopted for positioning the mobile broadcasting apparatus. FIG. 2A is a block diagram of a mobile broadcasting apparatus according to an embodiment of the present invention. The mobile broadcasting apparatus 20 according to an embodiment of the present invention includes a signal receiving unit 201, a play unit 203 and a memory unit 205. The signal receiving unit 201 is in signal connection to a wireless broadcast system 23 and a communication system 21. The play unit 203 is electrically connected to the signal receiving unit 201 and the memory unit 205.

In the mobile broadcasting apparatus 20, the signal receiving unit 201 can be in signal connection to the wireless broadcast system 23 and the communication system 21 at a same time. In the present invention, the position of the mobile broadcasting apparatus 20 is determined when the signal receiving unit 201 is in signal connection to the communication system 21. The position of the mobile broadcasting apparatus 20 can be done through multiple ways based on the communication system 21. For example, the position of the mobile broadcasting apparatus 20 can be directly determined if the signals, received by the signal receiving unit 201 from the communication system 21, contain information related to the position of the mobile broadcasting apparatus 20. That is, if the mobile broadcasting apparatus 20 is in signal connection to a mobile communication servo in a mobile communication system or a network servo in a network system, the position of the mobile broadcasting apparatus 20 is aware of by the mobile communication servo or the network servo via an identifying code of the mobile broadcasting apparatus 20. After a communication signal, containing the position information of the mobile broadcasting apparatus 20, is transmitted to the mobile broadcasting apparatus 20 from the mobile communication servo or the network servo, the mobile broadcasting apparatus 20 is positioned.

Alternatively, the position of the mobile broadcasting apparatus 20 can be determined by itself through further computing the communication signals transmitted to the signal receiving unit 201 from the communication system 21. FIG. 2B is a schematic diagram illustrating a mobile broadcasting apparatus 20 is positioned by computing communication signals transmitted from multiple communication base stations. As depicted in FIG. 2B, the communication system 21 includes three communication base stations 211, 213 and 215 in a specific zone, and the mobile broadcasting apparatus 20 is in signal connection to these three communication base stations 211, 213 and 215. Once the mobile broadcasting apparatus 20 is in signal connection to three communication base stations 211, 213 and 215, and the identifying signals of these three communication base stations 211, 213 and 215 are transmitted to the mobile broadcasting apparatus 20, the position of the mobile broadcasting apparatus 20 can be determined by itself according to the three identifying signals based on a specific algorithm, i.e., triangulation.

After the position of the mobile broadcasting apparatus 20 is determined according to communication signals transmitted from the communication system 21, a specific channel program can be played on the mobile broadcasting apparatus 20 via the broadcast station 231 in wireless broadcast system 23 as depicted in FIG. 2B, where the specific channel program is related to the position of the mobile broadcasting apparatus 20. For example, if the signal receiving unit 201 in the mobile broadcasting apparatus 20 is in signal connection to the communication system 21 and the mobile broadcasting apparatus 20 is positioned in first zone based on the communication signals transmitted from the communication system 21, a first channel information table corresponding to the first zone is selected from multiple channel information tables. In the present embodiment, the first channel information table contains information about multiple channel programs, such as a name of each of the channel programs and its corresponding frequency band; where the available channel programs contained in the first channel information table can be provided in the first zone. After the first channel information table corresponding to the first zone is provided, a user can select his desired channel program from the first channel information table and the desired channel program is then played on the mobile broadcasting apparatus 20. For example, if a first channel program is provided in the first channel information table and the first channel program is broadcasted by a first wireless broadcast signal at a first frequency band in the first zone, when a user select the first channel program for watching in the first zone, the signal receiving unit 201 is firstly in signal connection to the wireless broadcast system 23 in the first zone and the first wireless broadcast signal is then transmitted to the signal receiving unit 201 at the first frequency band, accordingly the first channel program is played on the play unit 203 in the mobile broadcasting apparatus 20.

If the mobile broadcasting apparatus 20 is positioned to the second zone based on the communication signals transmitted from the communication system 21, a second channel information table corresponding to the second zone is selected from multiple channel information tables. After the second channel information table corresponding to the second zone is provided, the same first channel program can be played on the mobile broadcasting apparatus 20. For example, if the first channel program is provided in the second channel information table and the first channel program is broadcasted by a second wireless broadcast signal at a second frequency band in the second zone, when the user still like to watch the first channel program in the second zone, the signal receiving unit 201 is firstly in signal connection to the wireless broadcast system 23 in the second zone and the second wireless broadcast signal is then transmitted to signal receiving unit 201 at the second frequency band, accordingly the first channel program is played on the play unit 203 in the mobile broadcasting apparatus 20.

In the present embodiment, the multiple channel information tables can be pre-stored in the memory unit 205 as depicted in FIG. 2A, and a specific channel information table is selected from the multiple channel information tables by the mobile broadcasting apparatus 20 according to the position of the mobile broadcasting apparatus 20. In other embodiments, a specific channel information table corresponding to the position of the mobile broadcasting apparatus 20 is directly transmitted from a mobile communication servo if the communication system 21 is a communication system, or directly transmitted from a network servo if the communication system 21 is a network system.

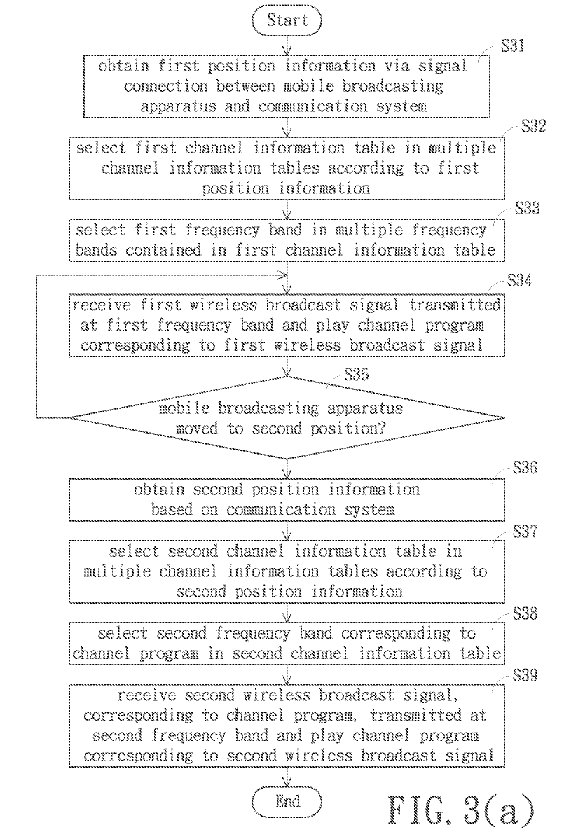

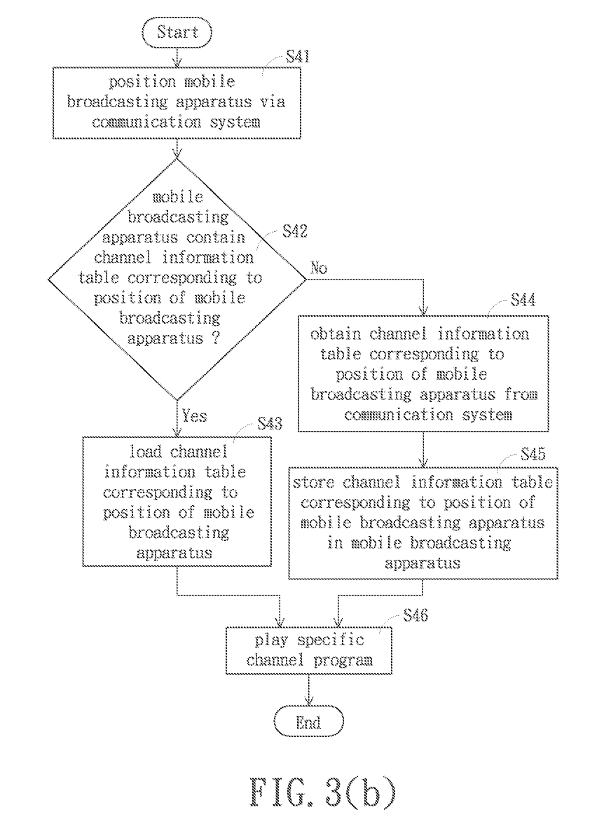

FIG. 3A is a flow chart of a broadcast broadcasting method applied to a mobile broadcasting apparatus according to an embodiment of the present invention. When the mobile broadcasting apparatus 20 is moved in a first zone, a first position information, related to the position of the mobile broadcasting apparatus 20 in the first zone, is obtained based on the communication system 21 (step S31). According to the first position information, a first channel information table is selected from multiple information tables (step S32). According to a user's selection, a first frequency band in multiple frequency bands included in the first information table is selected (step S33). A first wireless broadcast signal is then transmitted to the mobile broadcasting apparatus 20 from the wireless broadcast system 23 at the first frequency band, so that the specific channel program is played on the mobile broadcasting apparatus 20 (step S34).

If the mobile broadcasting apparatus 20 is positioned in a second zone, a second position information, related to the position of the mobile broadcasting apparatus 20 in the second zone, is obtained based on the communication system 21 (step S36). According to the second position information, a second channel information table is selected from multiple information tables (step S37). A second frequency band, corresponding to the specific channel program, is selected from the multiple frequency bands included in the second information table (step S38). A second wireless broadcast signal is then transmitted to the mobile broadcasting apparatus 20 from the wireless broadcast system 23 at the second frequency band, so that the specific channel program is played on the mobile broadcasting apparatus 20 (step S39).

Alternatively, if the mobile broadcasting apparatus 20 is not moved out of the first zone, it is understood that the specific channel program is still played on the mobile broadcasting apparatus 20 without any frequency band switching.

As described above, the steps S32 and S37 of selecting the first/second channel information table in multiple channel information tables can be done through the mobile broadcasting apparatus 20 by itself or a mobile communication servo or a network servo in the communication system 21. If these multiple channel information tables are pre-stored in the memory unit 205, the first/second channel information table in the multiple channel information tables is selected by the mobile broadcasting apparatus 20 according to the first/second position information. Alternatively in other embodiments, the first/second channel information table in the multiple channel information tables is firstly selected by the mobile communication servo or the network servo according to the first/second position information and then directly transmitted to the mobile broadcasting apparatus 20.

If the mobile broadcasting apparatus 20 is moved to a specific zone and the channel information table corresponding to the specific zone is not pre-stored in the memory unit 205, the channel information table corresponding to the specific zone can be obtained from a communication system. FIG. 3B is a flow chart of an operating method applied to a mobile broadcasting apparatus according to an embodiment of the present invention. The mobile broadcasting apparatus 20 is positioned based on a communication system which is in signal connection to the mobile broadcasting apparatus 20 (step 41). The mobile broadcasting apparatus 20 searches a channel information table corresponding to the position of the mobile broadcasting apparatus 20 in the memory unit 205 (step S42). If the channel information table corresponding to the position of the mobile broadcasting apparatus 20 is stored in the memory unit 205, the channel information table corresponding to the position of the mobile broadcasting apparatus 20 is then loaded from the memory unit 205 (step S43); alternatively, if the channel information table corresponding to the position of the mobile broadcasting apparatus 20 is not stored in the memory unit 205, the channel information table corresponding to the position of the mobile broadcasting apparatus 20 is obtained from the communication system (step S44). The obtained channel information table is then stored in the memory unit 205 (step S45). A specific channel program contained in the channel program table is played on the mobile broadcasting apparatus 20 (step S46).

It is understood that positioning the mobile broadcasting apparatus 20 of the present invention based on the signals transmitted from the communication system 21 can be implemented by software programs in the mobile broadcasting apparatus 20.

Moreover, the communication system 21 can be a 2G/3G mobile communication system.

Moreover, the signals received by the mobile broadcasting apparatus 20 of the present invention are not limited to a wireless digital TV broadcast signal. Other wireless broadcast signals, such as a wireless digital radio signal, can be also applied to the mobile broadcasting apparatus 20 of the present invention.

To sum up, if the mobile broadcasting apparatus 20 of the present invention is playing a channel program via a first frequency band in a first zone, the mobile broadcasting apparatus 20 of the present invention is automatically switched to a second frequency band for playing the same channel program when the mobile broadcasting apparatus 20 of the present invention is positioned to be moved to a second zone. Therefore, a user can watch a same channel program by the mobile broadcasting apparatus 20 of the present invention without switching the frequency bands when the mobile broadcasting apparatus 20 of the present invention is moved from the first zone to the second zone.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A mobile broadcasting method, applied to a mobile broadcasting apparatus with wireless channel program receiving function, comprising steps of:
obtaining a first position information of the mobile broadcasting apparatus via a signal connection between the mobile broadcasting apparatus and a communication system;
selecting a first channel information table from a plurality of channel information tables according to the first position information;
selecting a first frequency band from a plurality of frequency bands included in the first channel information table;
receiving a first wireless broadcast signal at the first frequency band and playing a channel program corresponding to the first wireless broadcast signal on the mobile broadcasting apparatus;
obtaining a second position information of the mobile broadcasting apparatus via a signal connection between the mobile broadcasting apparatus and the communication system when the mobile broadcasting apparatus is moved;
selecting a second channel information table from the plurality of channel information tables according to the second position information;
selecting a second frequency band, corresponding to the channel program, from the plurality of frequency bands included in the second channel information table; and
receiving a second wireless broadcast signal at the second frequency band and playing the channel program corresponding to the second wireless broadcast signal on the mobile broadcasting apparatus.

2. The mobile broadcasting method according to claim 1, wherein when the communication system is a mobile communication system, the step of selecting a first channel information table from a plurality of channel information tables according to the first position information further comprises steps of:
obtaining the plurality of channel information tables from a mobile communication servo of the mobile communication system; and
selecting the first channel information table from the plurality of channel information tables by the mobile communication servo according to the first position information.

3. The mobile broadcasting method according to claim 1, wherein when the communication system is a network system, the step of selecting a first channel information table from a plurality of channel information tables according to the first position information further comprises steps of:
obtaining the plurality of channel information tables from a network servo of the network system; and
selecting the first channel information table from the plurality of channel information tables by the network servo according to the first position information.

4. The mobile broadcasting method according to claim 1, wherein when the communication system is a mobile communication system, the step of selecting a first channel information table from a plurality of channel information tables according to the first position information further comprises steps of:
obtaining the plurality of channel information tables from a mobile communication servo of the mobile communication system; and
selecting the first channel information table from the plurality of channel information tables by the mobile broadcasting apparatus according to the first position information.

5. The mobile broadcasting method according to claim 1, wherein when the communication system is a network system, the step of selecting a first channel information table from a plurality of channel information tables according to the first position information further comprises steps of:
obtaining the plurality of channel information tables from a network servo of the network system; and
selecting the first channel information table from the plurality of channel information tables by the mobile broadcasting apparatus according to the first position information.

6. The mobile broadcasting method according to claim 1, wherein in the step of selecting a first frequency band from a plurality of frequency bands included in the first information table, the first frequency band is selected according to a channel program name; and the channel program name is selected by a user or preset in the mobile broadcasting apparatus.

7. A mobile broadcasting apparatus with wireless channel program receiving function, in signal connection to a communication system, the mobile broadcasting apparatus comprises:
a signal receiving unit, in signal connection to the communication system; and
a play unit electrically connected to the signal receiving unit;
wherein a first position information of the mobile broadcasting apparatus is obtained via the signal receiving unit in signal connection to the communication system when the mobile broadcasting apparatus is positioned in a first zone, a first channel information table in a plurality of channel information tables is selected according to the first position information, a first frequency band in a plurality of frequency bands included in the first channel information table is selected, a channel program corresponding to a first wireless broadcast signal is played on the play unit after the first wireless broadcast signal is transmitted to the signal receiving unit at the first frequency band; a second position information of the mobile broadcasting apparatus is obtained via the signal receiving unit in signal connection to the communication system when the mobile broadcasting apparatus is positioned in a second zone, a second channel information table in the plurality of channel information tables is selected according to the second position information, a second frequency band, corresponding to the channel program, in the plurality of frequency bands included in the second channel information table is selected, the channel program corresponding to a second wireless broadcast signal is played on the play unit after the second wireless broadcast signal is transmitted to the signal receiving unit at the second frequency band.

8. The mobile broadcasting apparatus with wireless channel program receiving function according to claim 7, further comprising:
a memory unit, electrically connected to the play unit, for storing the plurality of channel information tables.

9. The mobile broadcasting apparatus with wireless channel program receiving function according to claim 7, wherein the plurality of channel information tables are obtained from a mobile communication servo if the communication system is a mobile communication system.

10. The mobile broadcasting apparatus with wireless channel program receiving function according to claim 7, wherein the plurality of channel information tables are obtained from a network servo if the communication system is a network system.

11. The mobile broadcasting apparatus with wireless channel program receiving function according to claim 7, wherein the position information is obtained from the communication system or obtained through the mobile broadcasting apparatus by computing an identifying signal which is transmitted from the communication system.
